(19) United States
(12) Patent Application Publication
(10) Pub. No.: US 2020/0187232 A1
(43) Pub. Date: Jun. 11, 2020

(54) METHOD FOR OPERATING A NETWORK ENTITY, NETWORK ENTITY, METHOD TO OPERATE A USER EQUIPMENT, AND USER EQUIPMENT

(71) Applicant: NOKIA TECHNOLOGIES OY, Espoo (FI)

(72) Inventors: Andreas Maeder, Wuerzburg (DE); Athul Prasad, Helsinki (FI)

(73) Assignee: Nokia Technologies Oy, Espoo (FI)

(21) Appl. No.: 16/642,760

(22) PCT Filed: Aug. 31, 2017
(86) PCT No.: PCT/EP2017/071926

§ 371 Date: Feb. 27, 2020

(51) Int. Cl. H04W 72/12; H04L 1/18

(52) U.S. Cl. CPC H04W 72/1273; H04W 84/042; H04L 1/1887

(57) ABSTRACT

A method for operating a network entity (BS) for a cellular radio communications network (4) is provided, the method comprising: receiving first multicast/broadcast traffic data; buffering the first multicast/broadcast traffic data; transmitting the first multicast/broadcast traffic data via a first downlink channel (DMCH); receiving a retransmission request via an uplink channel (UFCH); determining second multicast/broadcast traffic data in dependence on the buffered first multicast data and in dependence on the received retransmission request; and transmitting the second multicast/broadcast traffic data via a second downlink channel (DRCH).

### FIELD OF THE INVENTION

The present invention relates to a method for operating a network entity for a cellular radio communications network, a network entity for operating a cellular radio communications network, a method to operate a user equipment of a cellular radio communications network, and a user equipment of a cellular radio communications network.

### BACKGROUND

Multicast and Broadcast networks coming under the umbrella of Multimedia Broadcast/Multicast Service (MBMS) has been a key component in Third Generation (3G) and Fourth Generation (4G) LTE-Advanced wireless networks, in enabling resource efficient content distribution. The content has mainly been TV broadcast and public safety (public warning systems and mission critical communication systems) in legacy broadband networks. Due to the improvement in the content quality requirements and time criticality, the amount of radio resources consumed for delivering the content has constantly been increasing with the passage of time. The content quality requirements have been constantly increasing with advanced video and audio codecs enhancing the quality of experience of the end users, and the network operators need to allocate higher amount of radio resources to efficiently and effectively deliver this content to the end user. The scarce amount of available spectral resources makes such content delivery over the air, increasingly challenging, especially when the media is broadcasted over a wide area.

The delivery of high-quality media content using unicast has been the main focus area of 5G so far. Currently the delivery of high-quality media content is assumed to be done using unicast. Enabling multicast/broadcast delivery of such content would be considered a significant disruption, which could enable mass deployments of 5G base stations and further enhance advanced technology adoption.

The latency and reliability requirements for new multi-cast applications like augmented reality (AR) or virtual reality with full immersion are so high that the known multi-cast transmission techniques are not sufficient. As an example, for VR, an end-to-end latency of 7 ms is required in order to avoid induction of motion-sickness at the user—“end-to-end” meaning here from content creation to the reception by the user through the eye. Similarly, the reliability requirements are very high in order to enable a smooth presentation of the content, avoiding “frame drops” which may also lead to an uncomfortable experience.

The low latency requirement reduces the potential of any kind of time-spreading techniques for improving reliability, while the extensive use of forward error correction (FEC) on application layer is prohibited by bandwidth considerations, and the computational complexity of such methods on the end-user device like VR glasses.

### SUMMARY

According to a first aspect a method for operating a network entity for a cellular radio communications network is provided, the method comprising: receiving first multicast/broadcast traffic data; buffering the first multicast/broadcast traffic data; transmitting the first multicast/broadcast traffic data via a first downlink channel; receiving a retransmission request via an uplink channel; determining second multicast/broadcast traffic data in dependence on the buffered first multicast data and in dependence on the received retransmission request; and transmitting the second multicast/broadcast traffic data via a second downlink channel.

According to a further aspect a network entity for operating a cellular radio communications network is provided, wherein the network entity comprises at least a processor, a memory, and at least one communication module, wherein the network entity is configured to: receive first multicast/broadcast traffic data; buffer the first multicast traffic; transmit the first multicast/broadcast traffic data via a first downlink channel; receive a retransmission request via an uplink channel; determine second multicast/broadcast traffic data in dependence on the buffered first multicast data and in dependence on the received retransmission request; and transmit the second multicast/broadcast traffic data via a second downlink channel.

A new mechanism is proposed which enables reliable transport of high-quality multi-cast traffic with very high latency and reliability requirements. Since multi-cast transmission on the air interface characteristically does not support reliability mechanisms like ARQ, HARQ, due to the user-centric nature of these mechanisms, we propose to use dedicated, low latency uplink channel of the air interface combined with a local high-speed buffering mechanism for IP multi-cast content at the side of the network entity. It is observed that in the considered system, with the help of the proposed feedback mechanism the bandwidth requirement can be reduced by 1/3rd as compared to a baseline broadcast.

The provision of the first downlink channel, the uplink channel and the second downlink channel provides an advantageous separation of the channels. Especially separating the first downlink channel and the second downlink channel provides the advantage that both channels can be configured differently, ea. with a different numerology. Furthermore, the separation provides a reduced or prevented interference between the channels.

Using the proposed methods, UE and network entity, the system can be optimized for the mean user thereby minimizing the system bandwidth requirement. There would be additional bandwidth required for the feedback, which is considered to be minimal, considering the minimal amount of information that is sent by the UE to the network entity to initiate the retransmission. The method also gives the system the flexibility to optimize in real-time the radio parameters used for the multicast transmission, thereby improving the spectral efficiency and reliability of such deployments.

According to an advantageous embodiment the retransmission request comprises a sequence information indicating the second multicast/broadcast traffic data, wherein the method further comprises a mapping of the sequence information to the second multicast/broadcast traffic data in the buffered first multicast/broadcast traffic data.

According to an advantageous embodiment the transmission of the first multicast/broadcast traffic data comprises: transmitting a data unit comprising payload and a sequence information indicating the data unit.

According to an advantageous embodiment the transmission of the second multicast/broadcast traffic data is conducted if a content expiration deadline of the second multicast/broadcast traffic data has not expired, and/or if the quality of the second downlink channel is above a threshold, and/or if the capacity of the second downlink channel to the respective user equipment is above a threshold, and/or if a relevance indication of the second multicast/broadcast traffic data is above a threshold.

Multi-cast content like video or augmented/virtual reality consists of important and less important content. For example, for video, different frame types are used—some which are key frames, which lead to significant quality drops, and some are “delta-frames”, where a frame could be omitted if this does not happen too often. Distinguishing according to a relevance indication reduces the load on the second downlink channel. Moreover, context-selective retransmissions prevent a complex implementation in the UE.

According to a further aspect a method to operate a user equipment of a cellular radio communications network is provided, the method comprising: receiving first multicast/broadcast traffic data via a first downlink channel; determining an absence of second multicast/broadcast traffic data in dependence on the received first multicast/broadcast traffic data; transmitting a retransmission request via an uplink channel in dependence on the determination of the absence of the second multicast/broadcast traffic data; and receiving the second multicast/broadcast traffic data via a second downlink channel.

According to another aspect a user equipment of a cellular radio communications network is provided, wherein the user equipment comprises at least a processor, a memory, and at least one communication module, wherein the user equipment is configured to: receive first multicast/broadcast traffic data via a first downlink channel; determine an absence of second multicast/broadcast traffic data in dependence on the received first multicast/broadcast traffic data; transmit a retransmission request via an uplink channel in dependence on the determination of the absence of the second multicast/broadcast traffic data; and receive the second multicast/broadcast traffic data via a second downlink channel.

An advantageous embodiment further comprises: determining a sequence information in dependence on the received first multicast/broadcast traffic data, wherein the retransmission request comprises the sequence information indicating the second multicast/broadcast traffic data.

An advantageous embodiment further comprises: determining whether the second multicast/broadcast traffic data has been received, receiving and buffering further first multicast/broadcast traffic data if the second multicast/broadcast traffic data has not been received; providing the buffer including the first and second multicast/broadcast traffic data when the second multicast/broadcast traffic data has been received.

An advantageous embodiment further comprises: starting a timer with a time duration when the absence of the second multicast/broadcast traffic data is determined; determining whether the second multicast/broadcast traffic data has been received; receiving and buffering further first multicast/broadcast traffic data if the second multicast/broadcast traffic data has not been received; providing the buffer comprising the first but not the second multicast/broadcast traffic data when the time duration of the timer has elapsed.

An advantageous embodiment of the determination of the absence of the second multicast/broadcast traffic data comprises: determining a first sequence number when receiving a first data unit of the first multicast/broadcast traffic data; determining an expected sequence number for a second data unit to be received in dependence on the first sequence number; determining a second sequence number when receiving the second data unit of the first multicast/broadcast traffic data; and determining the absence of second multicast/broadcast traffic data if the second sequence number is unequal the expected sequence number.

An advantageous embodiment of the determination of absence comprises that the second traffic data was not received or that the second traffic data was received corrupted.

According to an advantageous embodiment the second downlink channel is a unicast channel. Therefore, the transmission probability of the absent second multicast/broadcast traffic data is increased.

### BRIEF DESCRIPTION OF THE FIGURES

FIGS. 1, 2, 4, 5 and 6 each depicts a schematic flow chart;

FIG. 3 depicts schematically a cellular radio communications network;

FIG. 7 depicts a schematic sequence diagram; and

FIG. 8 depicts a schematic block diagram.

### DESCRIPTION OF THE EMBODIMENTS

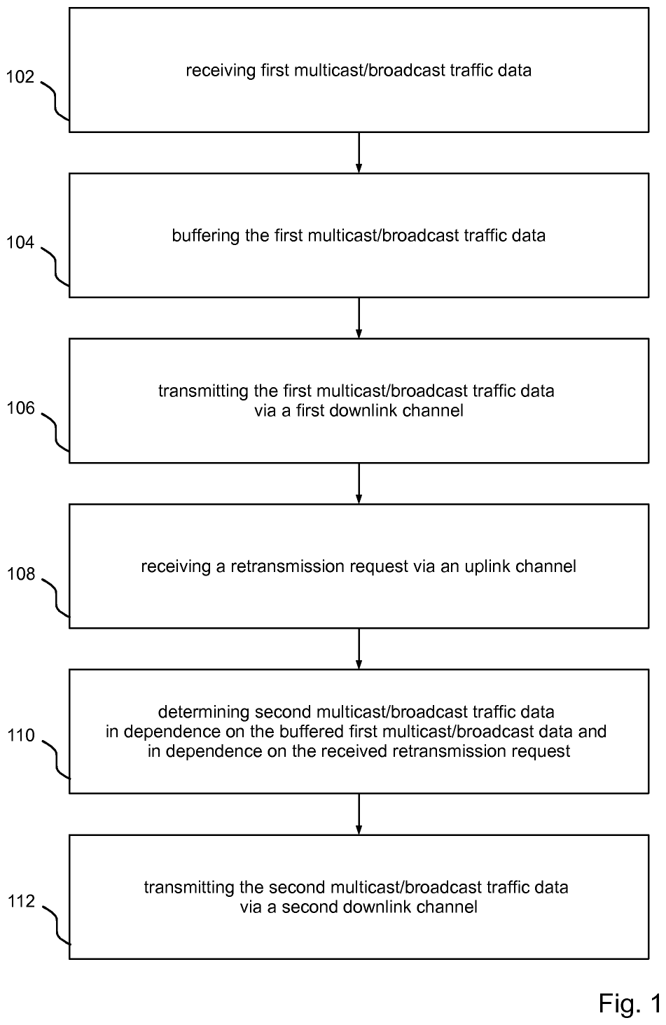

FIG. 1 shows a schematic flow chart for operating a network entity for a cellular radio communications network. A step 102 comprises a reception of first multicast/broadcast traffic data. A step 104 comprises buffering of the first multicast/broadcast traffic data. A step 106 comprises a transmission of the first multicast/broadcast traffic data via a first downlink channel. A step 108 comprises a reception of a retransmission request via an uplink channel. A step 110 comprises a determination of a second multicast/broadcast traffic data in dependence on the buffered first multicast data and in dependence on the received retransmission request. A step 112 comprises a transmission of the second multicast/broadcast traffic data via a second downlink channel. Examples of first and second multicast transmission data comprise video transmissions, radio transmissions, virtual reality transmissions.

The mechanisms exemplified in this description are applicable to the broadcast delivery of content to all the users within the coverage area of one or group of base stations in the sense of a multicast delivery. The broadcasted data could also be meant for a particular group of users, which are then able to receive and decrypt the data using application layer encryption.

The determination of the absence of the second multicast/broadcast traffic data comprises for example at least one of the following: a determination of a missing sequence number, an inability to decode the received second multicast/broadcast traffic data, an error regarding the decoding of the received second multicast/broadcast traffic data.

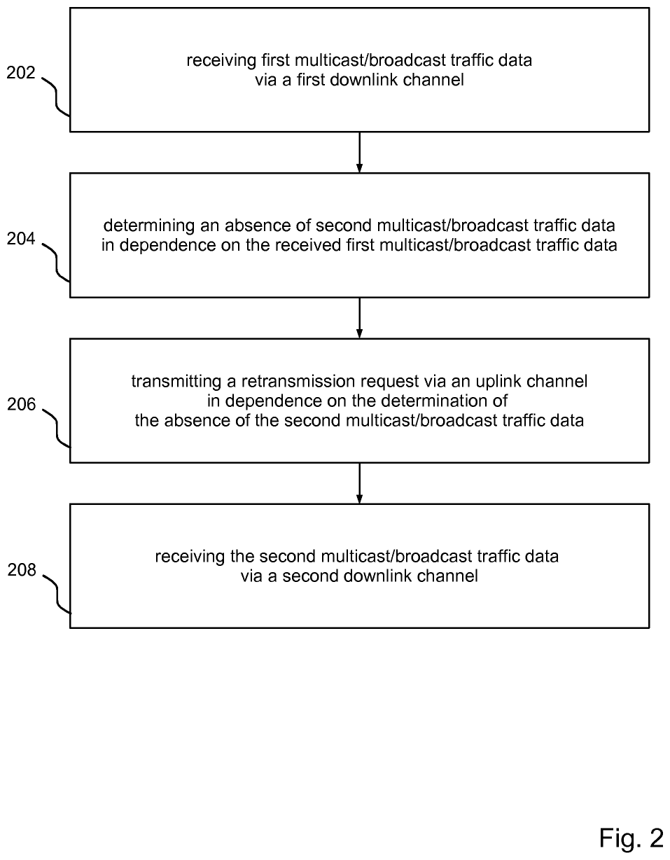

FIG. 2 shows a schematic flow chart for operating a user equipment of a cellular radio communications network. A step 202 comprises a reception of the first multicast/broadcast traffic data via the first downlink channel. A step 204 comprises a determination of an absence of the second multicast/broadcast traffic data in dependence on the received first multicast/broadcast traffic data. A step 206 comprises a transmission of the retransmission request via the uplink channel in dependence on the determination of the absence of the second multicast/broadcast traffic data. A step 208 comprises a reception of the second multicast/broadcast traffic data via the second downlink channel.

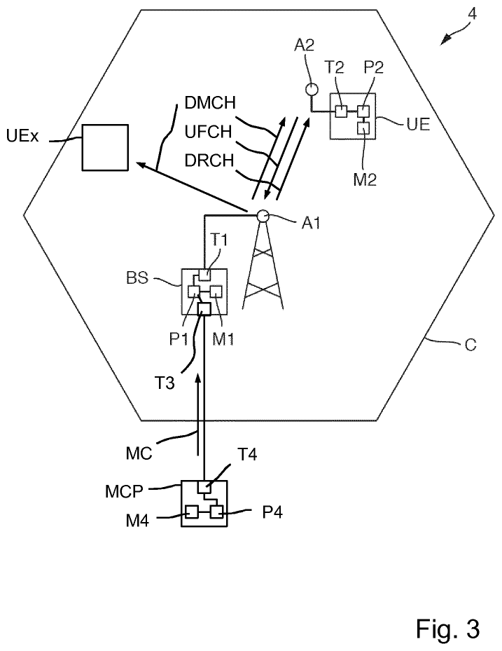

FIG. 3 shows schematically the cellular radio communications network 4 comprising the network entity BS and the user equipments UE, UEx. The network entity BS comprises a memory M1, a processor P1, and a communication module T1, especially a radio module, and a communication module T3. The network entity BS can be also termed eNodeB, base station or the like. In an embodiment parts of the functionality of the network entity BS are virtualized resulting in a plurality of computing entities realizing the function of the network entity BS. The network entity BS is connected to a stationary antenna A1 to transmit a first downlink channel DMCH, a second downlink channel DRCH and/or to receive an uplink channel UFCH. The first downlink channel DMCH is a 1-to-many connection in the sense that a plurality of UEs, for example the UE and the UEx receive the same first downlink channel DMCH. Both DRCH and UFCH are a 1-to-1 connection. The antenna A1 may comprise a plurality of antennas. The antenna A1 can be a remote radio head or the like. The network entity BS and the antenna A1 provides a radio coverage according to a cell C.

A multicast content provider MCP comprises a memory M4, a processor P4 and communication module T4. The multicast content provider MCP provides for example media content MC to the network entity BS. The received media content MC is being multicasted or broadcasted by the network entity BS as the first multicast/broadcast traffic data via the first downlink channel, which is to be received by a plurality of user equipments UEs. The first/second multicast/broadcast traffic data can be also termed first/second media data. When receiving the first multicast/broadcast traffic data at the network entity, this data can be provided via a broadcasting or multicasting.

If the second multicast/broadcast traffic data as part of the first multicast/broadcast traffic data is not received by the UE, the network entity retransmits the second multicast/broadcast traffic data on the second downlink channel DRCH if requested by the UE via the UFCH. In other words, the multi-cast enabled UE detects loss of transmitted multi-cast content. This can be realized either on radio protocol level, e.g. by inspection of RLC sequence numbers, on transport level, e.g. if real-time transmission protocol (RTP) is used, or on any other protocol level which provides the sequence information. The transmission of the second multicast/broadcast traffic data via the unicast second downlink channel DRCH requires that the UE requests the transmission of the second multicast data on the uplink channel UFCH. According to an embodiment the uplink channel UFCH is a physical control channel, PUCCH, or physical uplink shared channel, PUSCH, of a 4G or 5G cellular radio communications network.

The UE may be configured to send feedback for data which has been not retransmitted, but was indicated as incorrectly received. The network entity BS may prevent such a behaviour by indicating a “do not request” bit in the PDU with the highest SN which has been sent on the second downlink channel DRCH. According to an embodiment the second downlink channel DRCH is a physical downlink shared data channel, PDSCH, or a physical downlink control channel, PDCCH of a 4G or 5G cellular radio communications network.

The user equipment UE resides within the cell C and is able to receive the first downlink channel DMCH and the second downlink channel DRCH from the network entity BS and is able to transmit the uplink channel UFCH to the network entity BS. Both the first and the second downlink channels provide at least a logical separation. The user equipment UE comprises a memory M2, a processor P2, a communications module T2, especially a radio module, and an antenna A2. The user equipment UE is a mobile radio terminal or a machine-type radio terminal.

The second downlink channel DRCH and the uplink channel UFCH do not necessarily occupy many resources on the radio, but need to be configured in such way that low-latency transmission is possible. This is realized by configuring a short transmit time interval, sTTI, and related parameters for error correction and retransmission schemes (HARQ, ARQ) for DRCH and UFCH. The second downlink channel DRCH and the uplink channel UFCH can be realized on logical level as a new logical transport channel, or as a dedicated radio bearer which is setup by the network when multi-cast traffic is enabled on a multi-cast bearer, based on corresponding policies (e.g. as created and conveyed by a policy control).

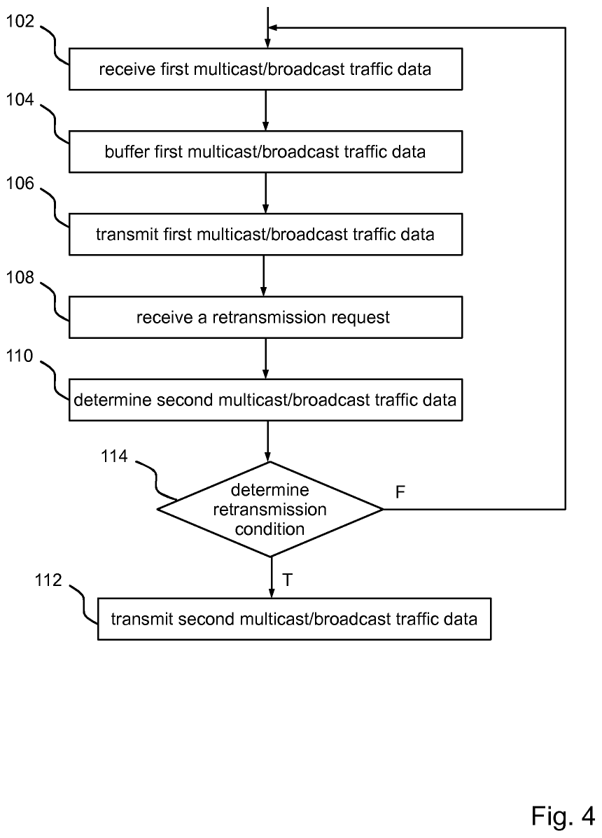

FIG. 4 shows a schematic flow chart for operating the network entity. Reference is made to the description of FIG. 1. The step 106 of transmitting the first multicast/broadcast traffic data comprises: transmitting a data unit comprising payload and a sequence information indicating the data unit. The step 110 of determining the second multicast/broadcast traffic data comprises: mapping a sequence information to the second multicast/broadcast traffic data in the buffered first multicast/broadcast traffic data, wherein the retransmission request comprises the sequence information indicating the second multicast/broadcast traffic data.

In step 114 a retransmission condition is determined. If the retransmission condition is true, the method proceeds with step 112. If the retransmission condition is false, the method proceeds with step 102. The transmission condition is true if a content expiration deadline of the second multicast/broadcast traffic data has not expired. For example, if an omitted second multicast/broadcast traffic data is a video frame at an elapsed position in time where the video frame is of no use anymore for the UE and this video frame will be not retransmitted by the network entity BS.

In another example, the retransmission condition is true if the quality of the second downlink channel to the respective user equipment is above a threshold. The quality of the second downlink channel can be expressed by using a CQI, Channel Quality Indicator.

In another example the, retransmission condition is true if the capacity of the second downlink channel to the respective user equipment is above a threshold.

In yet another example, the retransmission condition is true if a relevance indication of the second multicast/broadcast traffic data is above a threshold. An example for a relevance indication for video streams is that the relevance indication for a main frame has a value of two, whereas the relevance indication for a delta frame, which only transports a delta information to another frame, is one. The threshold set to 1 will result in main frames to be retransmitted whereas delta frames are not retransmitted. The step 114 therefore is content-aware.

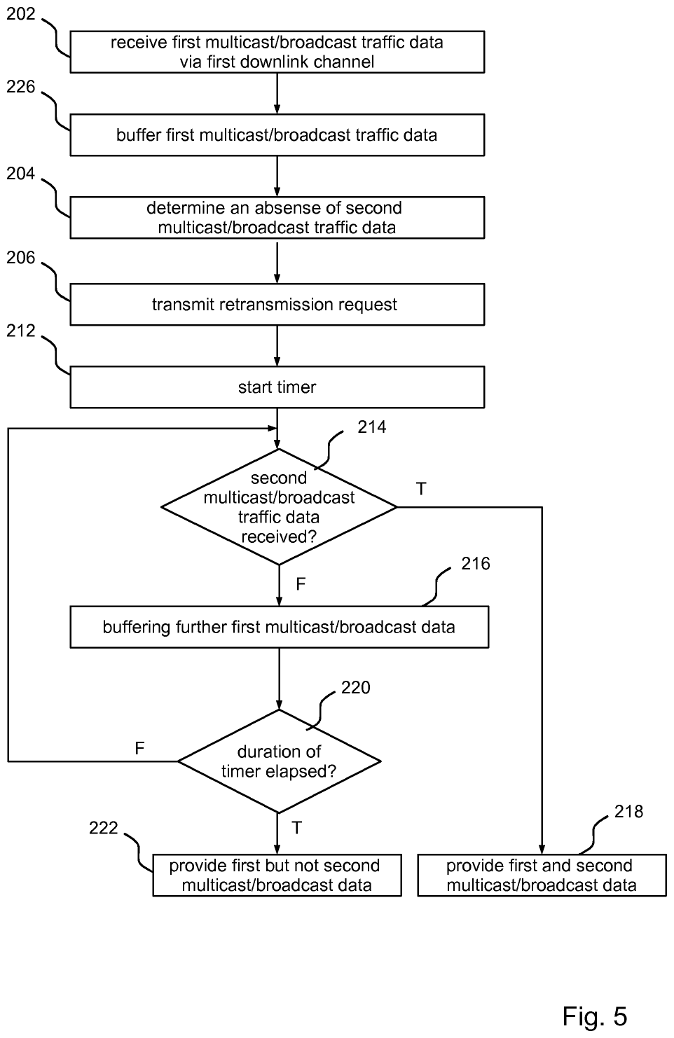

FIG. 5 shows a schematic flow chart to operate the user equipment. Reference is made to the description of FIG. 2. In a step 226 the received first multicast/broadcast traffic data is buffered. In step 212 a timer with a time duration is started as the absence of the second multicast/broadcast traffic data has been determined in step 204. According to a step 214 a determination is made whether the second multicast/broadcast traffic data has been received in response to the retransmission request. If this is not the case, further first multicast/broadcast traffic data is received and buffered in step 216. The buffer content including the first and second multicast/broadcast traffic data is provided to a further function in upper layers in step 218 if the second multicast/broadcast traffic data has been received in step 214. According to a step 220 a determination is made whether the duration of the timer has elapsed. If this is the case the buffer comprising the first but not the second multicast/broadcast traffic data is provided in step 222. If the time duration of the timer has not elapsed the procedure continues with step 214.

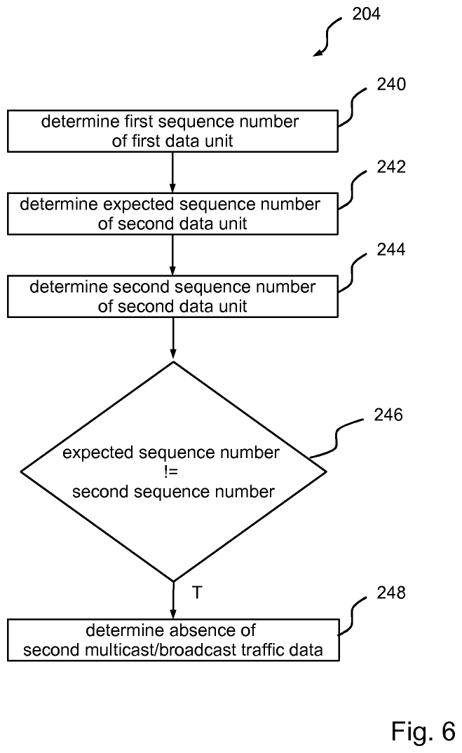

FIG. 6 shows an exemplary schematic flow chart of step 204 of FIG. 2 or 5. The determination of the absence of the second multicast/broadcast traffic data comprises a determination of a first sequence number in step 240 when receiving a first data unit of the first multicast/broadcast traffic data. A step 242 comprises: determining an expected sequence number for a second data unit to be received in dependence on the first sequence number. A step 244 comprises: determining a second sequence number when receiving the second data unit of the first multicast/broadcast traffic data. According to a step 246 a determination is made whether the second sequence number unequals the expected sequence number. If this is the case according to a step 248 the absence of second multicast/broadcast traffic data is determined. Alternatively or additionally to steps 244, 246 and 258 a determination is made that the second multicast/broadcast traffic data was received corrupted or that the UE was not able to decode the second multicast/broadcast traffic data.

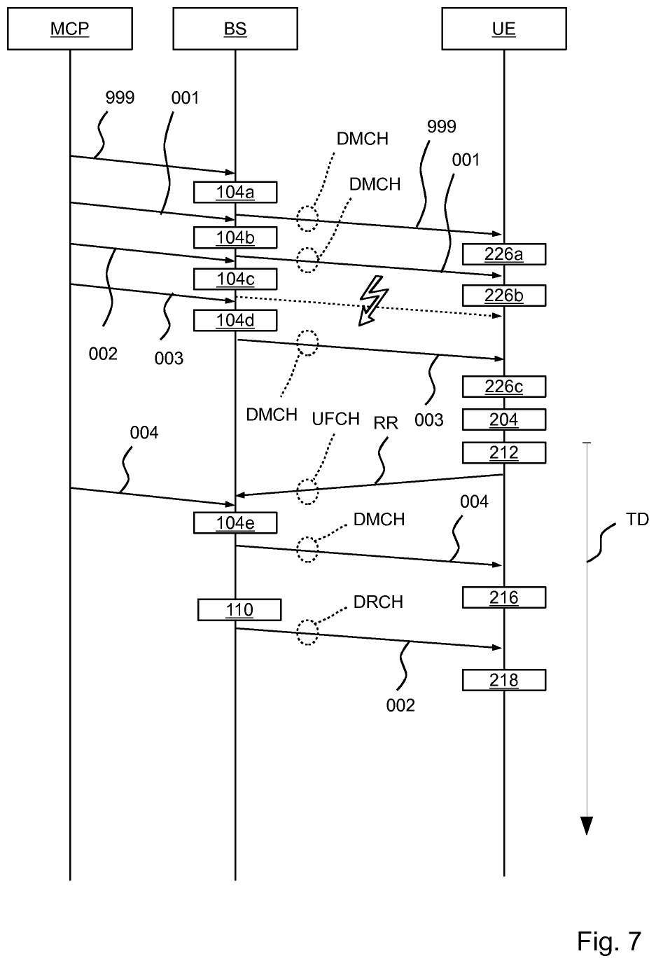

FIG. 7 shows a schematic sequence diagram. Data units 999, 001, 002, 003 and 004 representing the first multicast/broadcast traffic data are transmitted from the multicast content provided MCP to the network entity BS. The network entity BS buffers the received data units 999, 001, 002, 003 and 004 according to the steps 104a to 104e. The data units 990 and 001 are transmitted to the UE via the first downlink channel DMCH and are buffered in steps 226a and 226b.

The data unit 002 is buffered by the network entity BS in step 104c but the transmission to the UE is disrupted. After buffering the data unit 003 the UE is able to determine in step 204 the absence of data unit 002 in the sense of the absence of the second multicast data traffic. In step 212 the timer with the time duration TD is started.

As a response to the determination of the absence of the second multicast data the retransmission request RR comprising the sequence number of the missing data unit 002 is transmitted by the UE via the uplink channel UFCH to the network entity BS. The data unit 004 is forwarded by the network unit BS after buffering in the step 104b to the UE, where the data unit 004 is buffered in step 216.

In the step 110 the second multicast/broadcast traffic data in the form of the data unit 002 is retrieved by the network unit BS and is being transmitted via the second downlink channel DRCH to the UE, the second downlink channel DRCH being a unicast channel between the network entity BS and the UE.

After receiving the data unit 002, the buffered multicast/broadcast traffic data is released in step 218 and being provided to further function, for example for displaying the buffered multicast/broadcast traffic data in form of a video on a display of the UE.

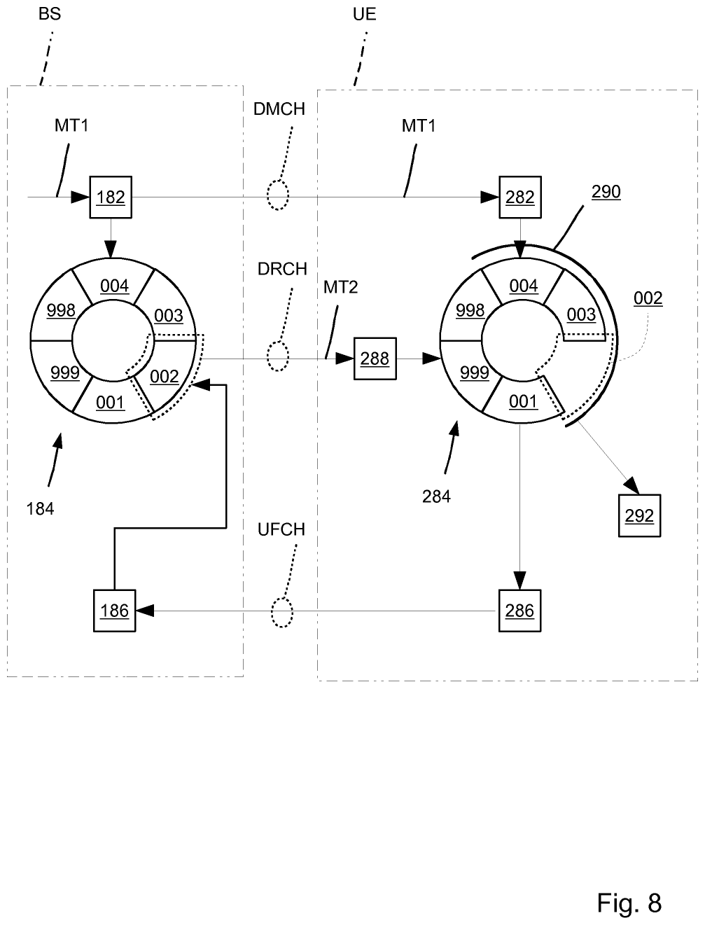

FIG. 8 shows a schematic block diagram of the network entity BS and the user equipment UE. A block 182 forwards the received first multicast/broadcast traffic data MT1 to the UE and inserts the respective data unit 004 into a content cache 184, which is exemplified as a ring buffer. A block 282 of the user equipment UE receives the multicast/broadcast traffic data MT1 and inserts the respective data unit 004 into a content cache 284, also exemplified as a ring buffer. A block 286 detects that a data unit 002 is missing and has not been inserted into the ring buffer 284. However, the data units 003 and 004 are received after the expected but not occurred reception of the data unit 002 and are inserted into the content cache 284. The absence of the data unit 002 is signalled with a sequence information to a block 186 of the network entity BS. The block 186 determines in dependence on the received sequence information that the data unit 002 has to be transmitted to the user equipment UE which has sent the retransmission request. The second multicast/broadcast traffic data is sent by the block 186 to the block 288 of the user equipment UE which inserts the block 002 into the content cache 284 between the data units 001 and 003. The block 288 releases and provides the buffer area 290 comprising the data units 002, 003 and 004 to a block 292 for further processing.

Some implementation details to the description above could be the following:

On the radio access network core network, RAN-CN, interface, multi-cast extension based on the SYNC protocol of 3GPP TS 25.446, “MBMS synchronisation protocol (SYNC),” v14.0.0, March 2017 could be used. The SYNC protocol also provides timing and sequence information for the multi-cast content. This can be used by the content cache function to build up a buffer of a certain length, e.g. several tens of milliseconds, with a related index and access functions. An approach would be the ring buffer.

If radio link control sequence number, RLC SN, is used for packet loss (RLC PDU) detection: RLC STATUS PDU could be used in the feedback channel similar as in RLC acknowledge mode. The BTS needs to maintain a mapping of RLC SN to the index in the content cache. Based on this mapping, the network entity BS requests the indices of the data from a content cache function.

In another embodiment, the network entity BS maintains a retransmission buffer for multicast radio link control protocol data units, MC RLC PDUs, of a certain length configured for the needs of the multicast service. Instead of mapping RLC SN to another index, the BTS selects the RLC PDUs directly based on the SN information.

If transport layer SN or other sequence information is used for loss detection: A dedicated bearer type of setup is used for the feedback/retransmission channel which terminates in the local content cache of the network entity. A local user plane function, UPF, is established between the network unit BS and the content cache in order to enable correct routing of user data. In the UE, buffering and merging of retransmitted content is done in the transport protocol stack or on application layer. For example, RTP SN can be used for this purpose.

The proposed method is not limited to the listed feedback mechanisms alone, but could be applied to more generic feedback such as quality of experience index, received signal quality levels, etc., using which the network entity could optimize its transmissions or initiate user-specific retransmissions. While the method is described from a multicast perspective, the mechanism are equally applicable to broadcast data transmissions as well.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term ‘processor’ should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow chart represents various processes which may be substantially represented in a computer readable medium and so executed by a computer or processor, whether or not such computer or processor is explicitly shown.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A method for operating a network entity for a cellular radio communications network, the method comprising:
receiving first multicast/broadcast traffic data;
buffering the first multicast/broadcast traffic data;
transmitting the first multicast/broadcast traffic data via a first downlink channel;
receiving a retransmission request via an uplink channel, wherein the uplink channel is realized as a dedicated radio bearer;
determining second multicast/broadcast traffic data in dependence on the buffered first multicast data and in dependence on the received retransmission request; and
transmitting the second multicast/broadcast traffic data via a second downlink channel, wherein the second downlink channel is realized as a dedicated radio bearer.

2. The method according to claim 1, wherein the retransmission request comprises a sequence information indicating the second multicast/broadcast traffic data, wherein the method further comprises:
mapping the sequence information to the second multicast/broadcast traffic data in the buffered first multicast/broadcast traffic data.

3. The method according to claim 1, wherein the transmission of the first multicast/broadcast traffic data comprises:
transmitting a data unit comprising payload and a sequence information indicating the data unit.

4. The method according to claim 1, wherein the transmission of the second multicast/broadcast traffic data is conducted if:
a content expiration deadline of the second multicast/broadcast traffic data has not expired, and/or
the quality of the second downlink channel is above a threshold, and/or
the capacity of the second downlink channel to the respective user equipment is above a threshold, and/or
a relevance indication of the second multicast/broadcast traffic data is above a threshold.

5. The method according to claim 1, wherein the second downlink channel is a unicast channel.

6. A network entity for operating a cellular radio communications network, wherein the network entity comprises at least a processor, a memory, and at least one communication module, wherein the network entity is configured to:
receive first multicast/broadcast traffic data;
buffer the first multicast traffic;
transmit the first multicast/broadcast traffic data via a first downlink channel;
receive a retransmission request via an uplink channel, wherein the uplink channel is realized as a dedicated radio bearer;
determine second multicast/broadcast traffic data in dependence on the buffered first multicast data and in dependence on the received retransmission request; and
transmit the second multicast/broadcast traffic data via a second downlink channel, wherein the second downlink channel is realized as a dedicated radio bearer.

7. A method to operate a user equipment of a cellular radio communications network, the method comprising:
receiving first multicast/broadcast traffic data via a first downlink channel;
determining an absence of second multicast/broadcast traffic data in dependence on the received first multicast/broadcast traffic data;
transmitting a retransmission request via an uplink channel in dependence on the determination of the absence of the second multicast/broadcast traffic data, wherein the uplink channel is realized as a dedicated radio bearer; and
receiving the second multicast/broadcast traffic data via a second downlink channel, wherein the second downlink channel is realized as a dedicated radio bearer.

8. The method according to claim 7, wherein the method further comprises:
determining a sequence information in dependence on the received first multicast/broadcast traffic data, wherein the retransmission request comprises the sequence information indicating the second multicast/broadcast traffic data.

9. The method according to claim 7, further comprising:
determining whether the second multicast/broadcast traffic data has been received;
receiving and buffering further first multicast/broadcast traffic data if the second multicast/broadcast traffic data has not been received;
providing the buffer including the first and second multicast/broadcast traffic data when the second multicast/broadcast traffic data has been received.

10. The method according to claim 7, further comprising:
starting a timer with a time duration when the absence of the second multicast/broadcast traffic data is determined;
determining whether the second multicast/broadcast traffic data has been received;
receiving and buffering further first multicast/broadcast traffic data if the second multicast/broadcast traffic data has not been received;
providing the buffer comprising the first but not the second multicast/broadcast traffic data when the time duration of the timer has elapsed.

11. The method according to claim 7, wherein the determination of absence of the second multicast/broadcast traffic data comprises:
determining a first sequence number when receiving a first data unit of the first multicast/broadcast traffic data;
determining an expected sequence number for a second data unit to be received in dependence on the first sequence number;
determining a second sequence number when receiving the second data unit of the first multicast/broadcast traffic data; and
determining the absence of second multicast/broadcast traffic data if the second sequence number unequals the expected sequence number.

12. The method according to claim 7, wherein the determination of absence comprises that the second traffic data was not received or that the second traffic data was received corrupted.

13. The method according to claim 7, wherein the second downlink channel is a unicast channel.

14. A user equipment of a cellular radio communications network, wherein the user equipment comprises at least a processor, a memory, and at least one communication module, wherein the user equipment is configured to:
receive first multicast/broadcast traffic data via a first downlink channel;
determine an absence of second multicast/broadcast traffic data in dependence on the received first multicast/broadcast traffic data;
transmit a retransmission request via an uplink channel in dependence on the determination of the absence of the second multicast/broadcast traffic data, wherein the uplink channel is realized as a dedicated radio bearer; and
receive the second multicast/broadcast traffic data via a second downlink channel, wherein the second downlink channel is realized as a dedicated radio bearer.

15. The method according to claim 7, wherein the method further comprises:
buffering and merging of retransmitted content is done on application layer.
